(19) United States
(12) Patent Application Publication
(10) Pub. No.: US 2006/0098024 A1
(43) Pub. Date: May 11, 2006

(54) Digital video signal data processor

(76) Inventor: Makoto Kohno, Tsuzuki-ku (JP)

Correspondence Address: Patent Legal Staff;Eastman Kodak Company, 343 State Street, Rochester, NY, 14650-2201, US

(21) Appl. No.: 11/243,580

(22) Filed: Oct. 5, 2005

(30) Foreign Application Priority Data
Oct. 18, 2004 (JP) 2004-302826

(51) Int. Cl. G09G 5/02

(52) U.S. Cl. 345/589

(57) ABSTRACT

A digital video signal data processor including a data conversion section for converting an input digital video signal data such that a gradation of the signal data within a signal level range can be finer than gradations within other signal level ranges; and a gamma correction table for performing a gamma correction on an input converted video signal data which was output from the data conversion section.

### FIELD OF THE INVENTION

The present invention relates to a digital video signal data processor. More specifically, the invention relates to a method for realizing gamma correction effective from the viewpoint of gradation.

### BACKGROUND OF THE INVENTION

Organic EL display devices are attracting attention for use as self-luminous flat-panel display devices. In a conventional organic EL display device, a pixel is formed by arranging an organic EL element in a matrix and display is performed by controlling an organic EL element in each pixel. Organic EL display devices can be divided into active type and passive type displays. Of these, active type display devices generally have a higher definition because active type display devices have a pixel circuit for controlling an electric current of the organic EL element in each pixel.

FIG. 1 shows an example of a pixel circuit of an active type organic EL display device. A driving TFT 1 is p-channel type and a source thereof is connected to a power supply PVdd extending vertically while a drain thereof is connected to an anode of an organic EL element 2. A cathode of the organic EL element 2 is connected to a cathode power supply CV A gate of the driving TFT 1 is connected to the power supply PVdd via a storage capacitor C and to a source of an n-channel type switching TFT 3, a drain of which is connected to a data line “Data” extending vertically and a gate of which is connected to a gate line “Gate” extending horizontally.

Therefore, by setting the gate line “Gate” at high level, a corresponding switching TFT 3 is turned on. At this point, when an image signal of a luminance of the pixel is applied to the data line “Data”, the voltage of the image signal is held in the storage capacitor C and the voltage is applied to the gate of the driving TFT 1. Consequently, the gate voltage of the driving TFT 1 is controlled by the image signal and the electric current flowing through the organic EL element 2 is also controlled. The storage capacitor C holds a gate-source voltage Vgs of the driving TFT 1 even after the switching TFT 3 is turned off.

Because the amount of light emitting of the organic EL element 2 is almost proportional to the driving current, the organic EL element 2 emits light in accordance with the image signal.

In the organic EL display device, because a relation (gamma) between a level of input signal and a display luminance is nonlinear, gamma correction is carried out to correct the relation.

FIG. 2 shows an example relationship between an input voltage (Vgs) and the luminance and electric current icv of the organic EL element 2. As shown in the graph, the gate-source voltage Vgs must match or exceed a predetermined threshold voltage (Vth) to turn the driving TFT 1 on in order for the organic EL element 2 to emit light. The image signal is basically data corresponding to an emission luminance, with the lowest level corresponding to black level. As such, it is necessary to set a black level offset for offsetting the image signal with the voltage corresponding to the threshold voltage Vth with regard to the data voltage to be supplied to the pixel circuit. Also, the pixel circuit is set to have a predetermined luminance at an input voltage Vw corresponding to white level.

When using a digital video signal data input as an input to an organic EL panel, the digital video signal data input is converted into an analog signal by a D/A converter and supplied to the pixel circuit as shown in FIG. 1. In consideration of the relationship shown in FIG. 2, the gamma correction is carried out by using a LUT (look-up table) in which an inverse characteristic to the characteristic of the input voltage and luminance in FIG. 2 is stored before being input to the D/A converter.

Japanese patent publication JP-A-2002-165111 discloses a related digital gamma correction using a LUT. In this related art, which relates to gamma correction of a liquid crystal projector, the number of bits input to a gamma correction LUT is increased so as to enhance correction accuracy in a black (dark) region in which the slope of gamma correction is high.

With the technology disclosed in JP-A-2002-165111, although the correction accuracy of black region can be improved, the size of the LUT becomes large as the number of bits of data input to the LUT increases. As increasing the size of the LUT requires a corresponding increase in the minimum size of the available memory, this is not preferable in terms of achieving a compact, low-cost circuit.

### SUMMARY OF THE INVENTION

The present invention provides a digital video signal data processor capable of carrying out a gamma correction with high accuracy even with a small-sized LUT.

A digital video signal data processor according to the present invention comprises a data conversion section for converting an input digital video signal data such that a gradation of the signal data within a signal level range in which the gradation is to be protected can be relatively finer than gradations within other signal level ranges; and a gamma correction table for performing gamma correction on a converted video signal data which was output from the data conversion section.

The signal level range in which the gradation is to be protected is the signal level range in which a slope of gamma correction curve is high. In the signal level range in which a slope of gamma correction curve is high, because a gamma correction output changes largely relative to the change of input, an error of correction can be prevented from increasing in such a range by making the gradation of input signal to the gamma correction finer than other ranges. In a range in which a slope of gamma correction curve is low, since an output value does not change largely even when an input value changes to some extent, a large reduction of gradation to be allocated does not have an influence very much in such a range. According to the present invention, the overall bit width of an input digital video signal data can be compressed, while maintaining the gradations within the range in which the gradations should be preserved. Therefore, deteriorations in correction accuracy can be prevented, even when the table size of gamma correction table after a bit width reduction section is reduced.

In one aspect, a data conversion section according to the present invention is a bit width reduction section for reducing a bit width of the digital video signal data by maintaining the gradation within the signal level range in which the gradation is to be protected and by compressing the gradation within other signal level ranges in the digital video signal data which has been input.

In another aspect, a data conversion section according to the present invention comprises a contrast adjustment section for multiplying a contrast coefficient for the digital video signal data which has been input and for outputting output video signal data with greater bit width than the digital video signal data; and a bit number reduction section for reducing a bit width of the output video signal data in accordance with an input bit width of the gamma correction table by maintaining the gradation within the signal level range in which the gradation is to be protected and by compressing the gradation within other signal level ranges in the output video signal data output from the contrast adjustment section.

In a further aspect of the present invention, the bit width reduction section compresses the gradation relatively largely as a luminance of the signal level range becomes high by making a proportion of an increase in output to an increase in input small as the luminance of the signal level range becomes high.

In a still further aspect of the invention, the bit width reduction section comprises: a data merging section for generating an output increasing linearly relatively to an increase in input by dividing the signal level range of the digital video signal data which has been input to a plurality of signal level ranges which can be identified by values of several bits on higher-order side in order of the signal level range with a highest-order bit of 1, the signal level range with a highest-order bit of 0 and a second-order bit of 1 and so on and by merging higher-order bits representing a range with a part of the digital video signal data in each signal level range; and a selector for selecting the output from the data merging section by each bit of higher-order of the digital video signal data.

### BRIEF DESCRIPTION OF THE DRAWINGS

FIG. 1 shows a portion of a pixel circuit of an organic EL element;

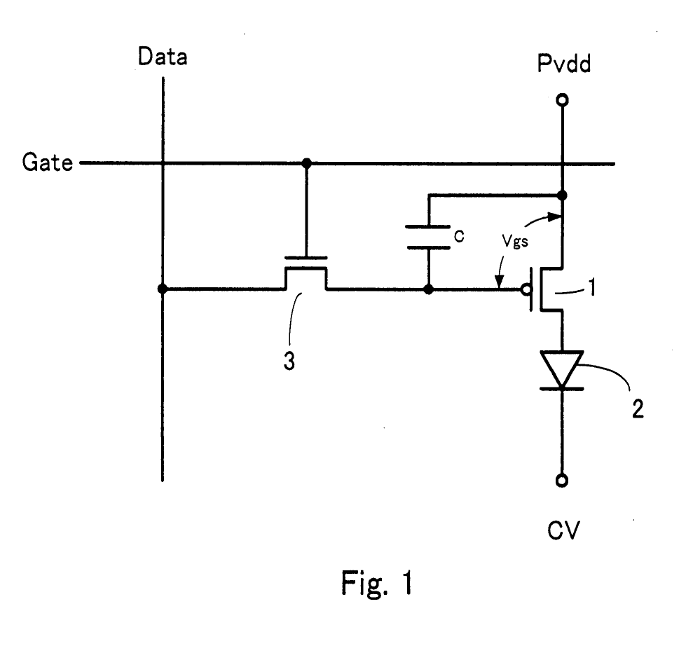

FIG. 2 shows an example relationship between an input (voltage) and an output (emission luminance) of an organic EL element according to the present invention;

FIG. 3 is a block diagram showing a configuration of an embodiment of a digital video signal data processor according to the present invention;

FIG. 4 shows an input/output characteristic of a bit width reduction section;

FIG. 5 shows an example of an internal configuration of the bit width reduction section having the input/output characteristic shown in FIG. 4;

FIG. 6 is a diagram in which a gamma table of LUT of the embodiment and a conventional gamma table are compared;

FIG. 7 is a block diagram showing a configuration of an operative example of the digital video signal data processor;

FIG. 8 is a diagram showing a relation between an input to a contrast adjustment section and an input to a gamma correction LUT;

FIG. 9 shows input/output characteristics of the bit width reduction section in which the bit width is reduced by two bits; and

FIG. 10 shows an example of an internal configuration of the bit width reduction section having the input/output characteristics shown in FIG. 9.

### DESCRIPTION OF THE PREFERRED EMBODIMENTS

Hereinafter, a preferred embodiment of the present invention, will be described in reference to the drawings.

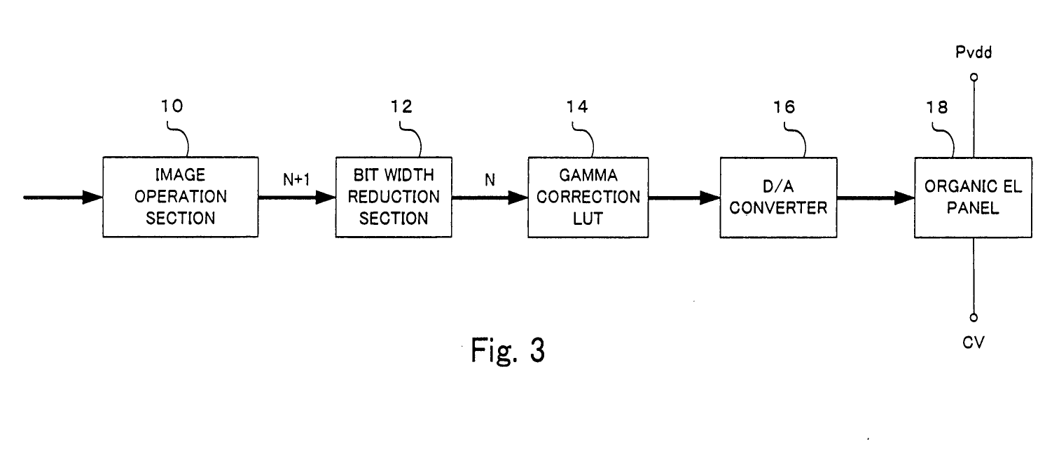

FIG. 3 is a block diagram showing a configuration of an embodiment of a digital video signal data processor according to the present invention. In FIG. 3, an image operation section 10 is a unit for generating digital video signal data to be displayed on an organic EL panel 18. The image operation section 10 may be any device or program which can output the digital video signal data. In this embodiment, a bit width (data width) of the digital video signal data output from the image operation section 10 is set to be (N+1) bits (N is a natural number).

The digital video signal data of (N+1) bit width output from the image operation section 10 is input to a bit width reduction section 12, which reduces the bit width of the input digital video signal data. In the example shown in FIG. 3, the bit width of the input data is reduced from (N+1) bits to N bits. However, the bit width is not uniformly reduced over the entire range of the video signal. The gradation of signal level range in which higher correction accuracy is desired is relatively less compressed than other signal level ranges.

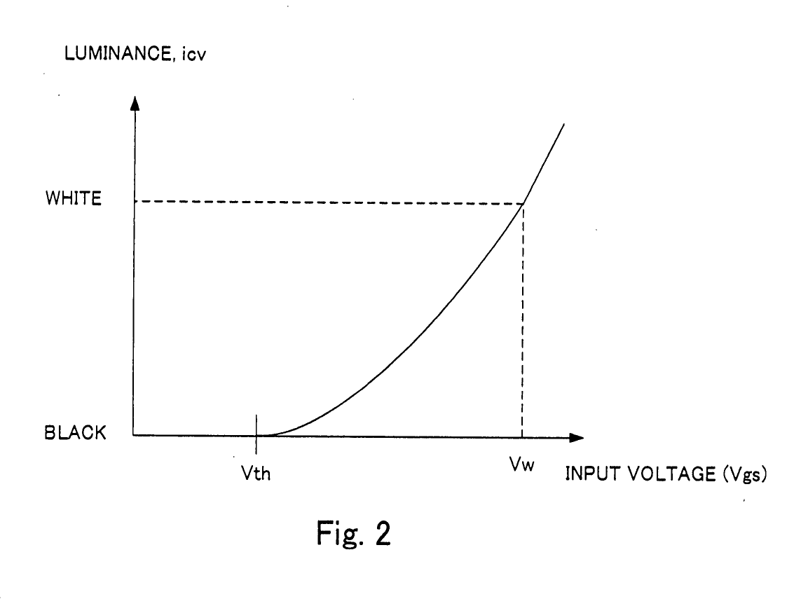

In an example win which a device as shown in FIG. 3 applied to the organic EL panel 18, because an input/output relationship of an organic EL element is as shown FIG. 2, the slope of the gamma correction curve for correcting the relationship to be proportional is high in the region with low signal level (that is, low luminance) and low in the region with high signal level. In the region with a high slope, a small difference of input signal value results in a large error in this output signal. For this reason, more gradations are allocated to the region of low luminance than the region of high luminance in order to secure, in the region of low luminance, a correction accuracy with a high slope, as in JP-A-2002-165111.

In the example of FIG. 3, because the bit width is reduced from (N+1) bits to N bits, a method is employed in which the gradation of region of low luminance is not compressed while the gradation of region of high luminance is compressed by two bits.

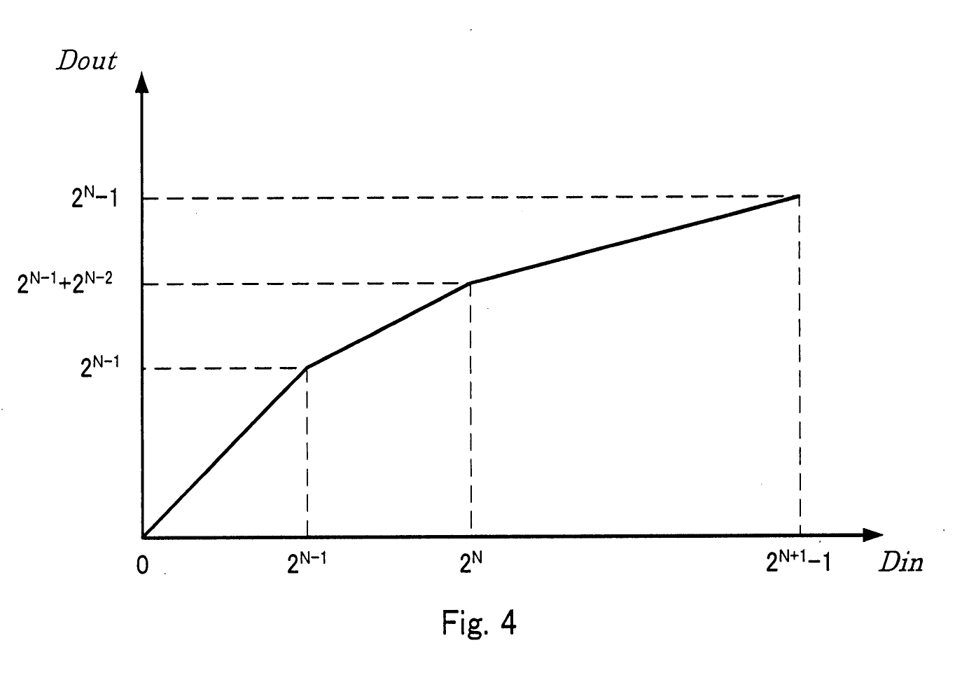

FIG. 4 shows input/output characteristics of the example bit width reduction section 12 in accordance with this method. This characteristic shows a relationship between a value of digital video signal data Din of (N+1) bit width input to the bit width reduction section 12 and a value of digital video signal data Dout of N bit width output from the bit width reduction section 12. The characteristic is shown by the following formula.

$$Dout = \{ \begin{matrix}Din & ( 0 \leq Din \leq {2}^{N - 1} - 1 ) \\ Din / 2 + {2}^{N - 2} & ( {2}^{N - 1} \leq Din \leq {2}^{N} - 1 ) \\ Din / 4 + {2}^{N - 1} & ( {2}^{N} \leq Din \leq {2}^{N + 1} - 1 )\end{matrix} \qquad ( 1 )$$

In the characteristic, in the lower (that is, low luminance side) quarter of the signal level of the input signal Din, i.e., in the range of the signal level 0 to 2^{N-1}−1, the value of the output signal Dout is equal to the value of the input signal Din, and the graph showing the characteristic has a slope of 1. In the next quarter of the input signal Din, i.e., in the range of the signal level 2^{N-1} to 2^{N}−1, the slope of graph showing the characteristic is ½. In the higher half of the input signal Din, i.e., in the range of the signal level 2^{N} to 2^{N+1}−1, the slope of graph showing the characteristic is ¼. In this manner, by lowering the slope of input/output characteristic gradually as the value of the input signal Din becomes large, the bit width of the output signal Dout becomes smaller than the bit width of input signal Din by one bit.

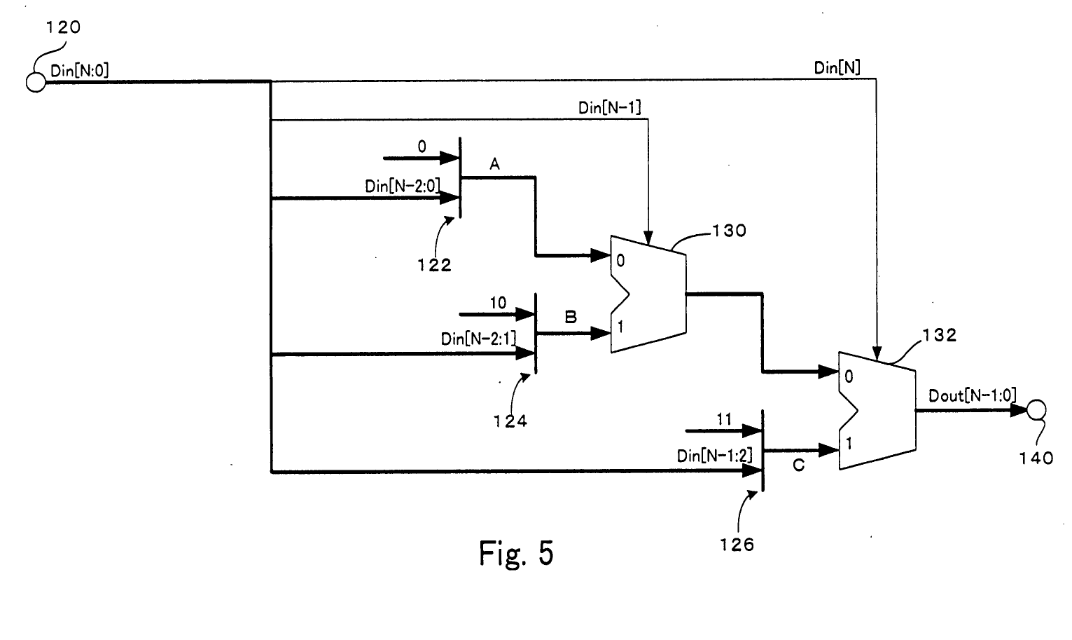

FIG. 5 shows an example of an internal configuration of the bit width reduction section 12 showing the input/output characteristic as described above.

In this Figure, “Din[ ]” shows the input signal Din or a part thereof while “Dout[ ]” shows the output signal Dout. Also, “[m:n]” (0≦n<m) of “Din[N:0]” and “Dout[N−1:0]” and so on shows a value of (m−n+1) bit from n-th bit to m-th bit of the lower bit of the signal when a place number increasing from zero in incremental units of one bit is assigned to each bit of the input or output digital video signal data. Therefore, for example, “Din[N:0]” shows a value from zeroth bit (lowest) to N-th bit (highest) of the input signal Din of (N+1) bit, i.e., Din itself, which is input from an input section 120 of the bit width reduction section 12. When only one integer exists within “[ ]” such as “Din[N]”, “Din[N]” shows a value of one bit of the place shown by the integer. Consequently, for example, “Din[N]” shows a value of the highest bit of the input signal Din.

Data merging sections 122, 124 and 126 are circuits for merging two sets of input data. More specifically, upper binary data is merged into high order side of lower input data of the two sets of input binary. Therefore, when the upper and lower input data are m bit and n bit respectively, the output data from the data merging section becomes (m+n) bit of data. For example, when the lower input data is 6 bits of data “100000” and the upper input data is 2 bits of data “10”, the output from the data merging section becomes eight bits of data “10100000”.

More specifically, the data merging section 122 generates data A of N bit by merging “0” into high order side of value “Din[N−2:0]” of lower (N−1) bit of the input signal Din of (N+1) bit. The data A corresponds to the output data Dout in the case of 0≦Din≦2^{N-1}−1 in the above formula (1).

The data merging section 124 generates data B of N bit by merging “10” into high order side of value “Din[N−2:1]” from the second bit from lower bit (place number 1) to the place number (N−2) of the input signal Din. The data B corresponds to the output data Dout in the case of 2^{N-1}≦Din≦2^{N}−1 in the above formula (1).

The data merging section 126 generates data C of N bit by merging “11” into high order side of value “Din[N−1:2]” of higher (N−1) bit of the input signal Din. The data C corresponds to the output data Dout in the case of 2^{N}≦Din≦2^{N+1}−1 in the above formula (1).

To a selector 130, the output data A from the data merging section 122 and the output data B from the data merging section 124 are input. The selector 130 receives the value “Din[N−1]” of the second bit from higher bit of the input data Din as a selection signal, and selects and outputs the data A when the selection signal is 0 while selecting and outputting the data B when the selection signal is 1.

To a selector 132, the output data from the selector 130 and the output data C from the data merging section 126 are input. The selector 132 selects and outputs the output data from the selector 130 when the value “Din[N]” of the highest bit of the input data Din is 0 while selecting and outputting the data C when the value is 1. The output from the selector 132 is output from an output section 140 as the output from the bit width reduction section 12.

When the highest bit of the input data Din is “0” and the next highest bit is also “0”, the range of Din falls within 0≦Din≦2^{N-1}−1. At this time, since the data A becomes the output from the bit width reduction section 12 with the selections in the selectors 130 and 132, the relationship shown on the first line of the formula (1) can be realized. When the highest bit of the input data Din is “0” and the second bit from the highest bit is “1”, the range of Din falls within 2^{N-1}≦Din≦2^{N}−1. At this time, since the data B becomes the output from the bit width reduction section 12 with the selections in the selectors 130 and 132, the relationship shown on the second line of the formula (1) can be realized. Also, when the highest bit of the input data Din is “1”, the range of Din falls within 2^{N}≦Din≦2^{N+1}−1. Therefore, when the selector 132 selects the data C as the output from the bit width reduction section 12 in the case of the highest bit “1”, the relationship shown on the third line of the formula (1) can be realized.

As described above, the bit width reduction in accordance with the relationship shown in FIG. 4 and the formula (1) can be realized by a simple circuitry in which the output is selected by the values of high two bits of the input data Din as shown in FIG. 5.

After describing the bit width reduction section 12, the description will return to the configuration illustrated in FIG. 3. The video signal data in which the bit width has been reduced (compressed) to N bit in the bit width reduction section 12 is input to a gamma correction LUT 14. The LUT 14, which is a look-up table holding the gamma-corrected value corresponding to each value of the video signal data, outputs the gamma-corrected data value corresponding to the video signal data input from the bit width reduction section 12.

Because the input video signal data to be input to the gamma correction LUT 14 is compressed in the gradation in accordance with the characteristic shown in FIG. 4, the weight of gradation differs from weighting in a conventional art, but to which the gamma correction LUT 14 is required to correspond. To account for this difference, the gamma table which is contents of the gamma correction LUT 14 will be created using the following steps.

First, the gamma table to be gamma-corrected appropriately in the case where the bit number of the input data to the gamma correction LUT is N+1 is created using a conventional process. Then, one quarter of the data from the thus-created gamma table, i.e., 2^{N-1} sets of table data, are registered in the gamma table without processing; from a further quarter, i.e., 2^{N-1} sets of table data, are half of the data are selected and registered in the gamma table; and, from the remaining half of the data, i.e., 2^{N} sets of table data, one fourth of the data is selected and registered in the gamma table of this embodiment. In the present embodiment, it is sufficient if the thinning of data is achieved by selecting an average of two sets of data, an average of four sets of data, and so on, in accordance with a predetermined rule.

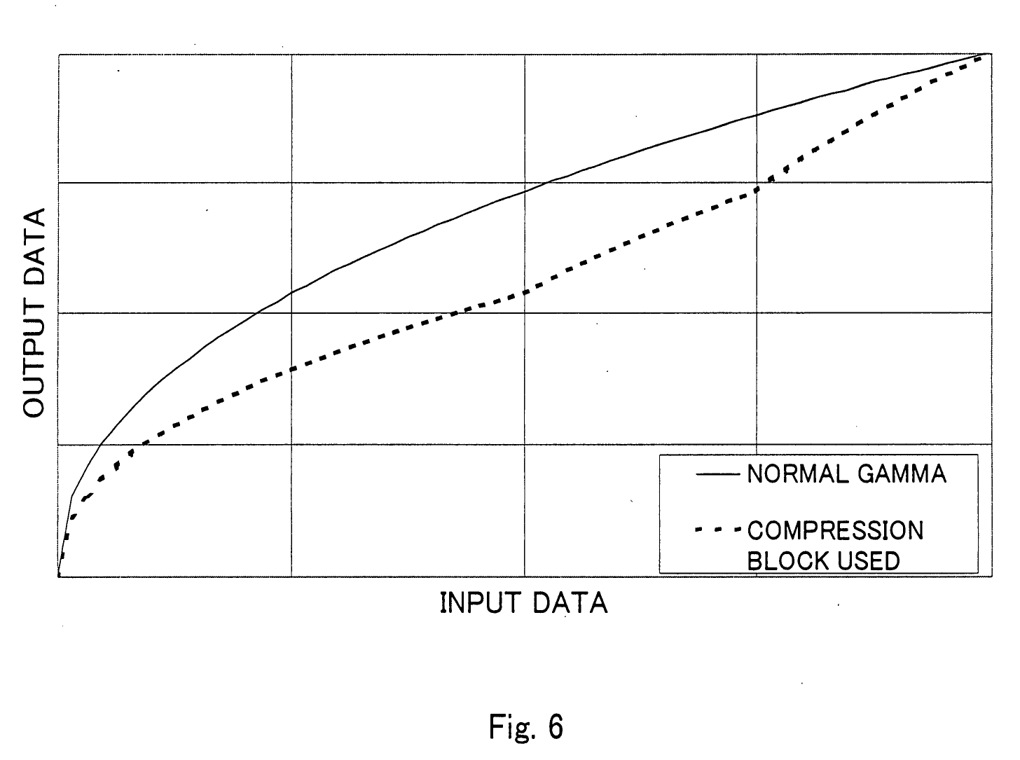

FIG. 6 shows an input/output relationship (gamma correction curve) between the gamma table created in this embodiment and a gamma table created as a result of a conventional method. In FIG. 6, the solid line shows the input/output relationship of the conventional gamma table and the dotted line shows the input/output relationship of the gamma table of the present embodiment when a compression block, i.e., the bit width reduction section 12, is employed. In the gamma table of the embodiment, as shown in FIG. 6, the slope of the gamma correction curve in the black (low luminance) region is lower than that of the conventional art, and the number of gradation increases in the black region. Also, the slope of the curve of the input/output relationship in the embodiment is more uniform than that in the conventional art, which shows that the entire region of table can be used effectively.

By storing the gamma table according to this embodiment in the LUT 14 after the bit width reduction section 12 having a characteristic as shown in FIG. 4, appropriate gamma correction can be achieved.

In addition, the bit width of the output data from the gamma correction LUT 14 can be properly selected in accordance with an application. In Japanese patent publication JP-A-2000-20037, for example, the number of gradations in a gray region in which the slope of the gamma correction curve is low is increased as a result of a two-bit increase in the bit width of data output from the gamma correction LUT from the bit width of the video signal data input to a signal processing system of display device. Also in the present embodiment, the bit width of the output from the gamma correction LUT 14 can be set to a value greater than that of the input to the digital video signal data processor, making it possible to lessen the degree of deterioration of gradation from the gray to white regions in which the slope of gamma correction curve is relatively low even in this embodiment. Also, when reduction of the data volume of gamma correction LUT 14 is desired, reduction of the bit width of the output from the LUT 14 is sufficient. In this embodiment, because the curve of gamma correction LUT has superior characteristics almost proportional compared to the conventional characteristic, improvement of gradation can be expected. This effect can be obtained regardless of the bit width of data output from the LUT 14.

The output from the gamma correction LUT 14 is converted to an analog signal by a D/A converter 16 and supplied to the organic EL panel 18.

In the example as described above, the bit width of the signal to be input to the gamma correction LUT 14 is compressed by gradually reducing the gradation to be allocated to the signal from low luminance to high luminance. When driving the organic EL element, because the input voltage varies more in the black region than in the white region when the luminance is changed in both regions at the same level, the data size of signal can be reduced as a whole in the bit width compression as described above in which relatively many gradations are allocated to the black region, while preventing the deterioration of correction accuracy in the black region. Consequently, the data size of gamma correction LUT 14 can be reduced.

In the example described above, the weight of bit width allocation is classified in the bit width reduction section 12 to allocate a greater bit width in the signal level range of lower luminance, which is a preferable example of gamma correction of a data signal for driving an organic EL element. In a case wherein the target to be driven changes, it is sufficient that the weight of bit width allocation is classified in accordance with the gamma characteristic of the target. In either case, it suffices if a great bit width is allocated to secure the correction accuracy in the signal level range in which the slope of gamma correction curve is steep.

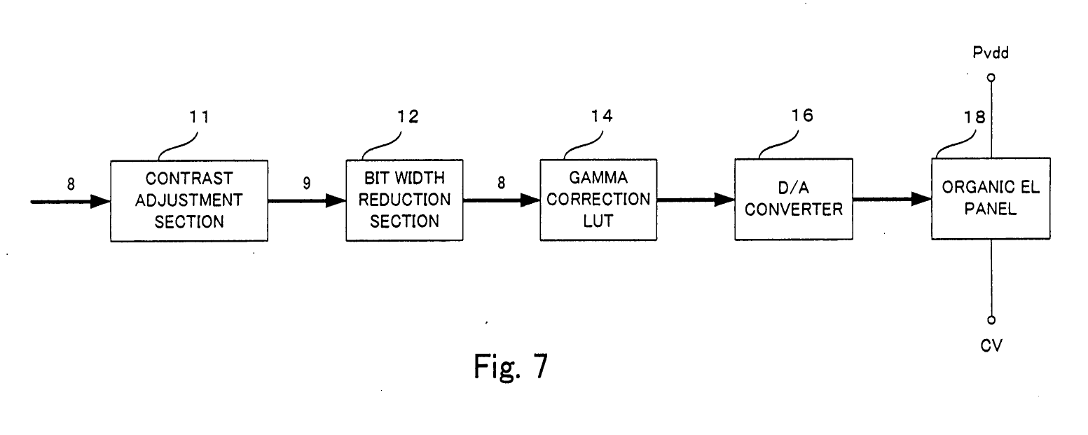

Next, an example as shown in FIG. 7 will be described as an operative example of the digital video signal data processor according to the present embodiment. In this example, a contrast adjustment section 11 is provided at the final stage of the image operation section 10 illustrated in FIG. 3. The bit widths of an input to the contrast adjustment section 11, the output from the bit width reduction section 12, and the input to the gamma correction LUT 14 are set at 8 bits, while the bit widths of an output from the contrast adjustment section 11 and the input to the bit width reduction section 12 are set at 9 bits.

The contrast adjustment section 11 adjusts the contrast of the video signal data of 8-bit width which has been input to convert the data to 9-bit width data. The contrast adjustment section 11 generates output data by multiplying a contrast coefficient by the input video signal data as in the fifteenth to seventeenth paragraphs in JP-A-2002-165111 and by rounding one or more lower place bits of result from the multiplication by rounding off, rounding down, or the like.

For example, when the contrast coefficient is an 8-bit value comprising a 2-bit integer portion and a 6-bit fractional portion, the coefficient showing contrast value 1 becomes “01.000000” and the coefficient showing contrast value ½ becomes “00.100000”. Multiplying such a coefficient as these by an 8-bit input signal and rounding to the lower 5 bits, an 11-bit value can be obtained. This data can be taken as data with 10-bit integer portion and 1-bit fractional portion. Because the values of the higher 2 bits are 0 when the contrast value is 1 or less, the result of contrast adjustment becomes data expressed by 9 bits with an 8-bit integer portion and a 1-bit fractional portion. When the contrast value exceeds 1, the bit width of the output from the contrast adjustment section 11 can be set at 9 bits, with the result of contrast adjustment saturated by a maximum value of 9-bit data.

The 9-bit data output from the contrast adjustment section 11 is compressed to 8 bits by the bit width reduction section 12 and input to the gamma correction LUT 14.

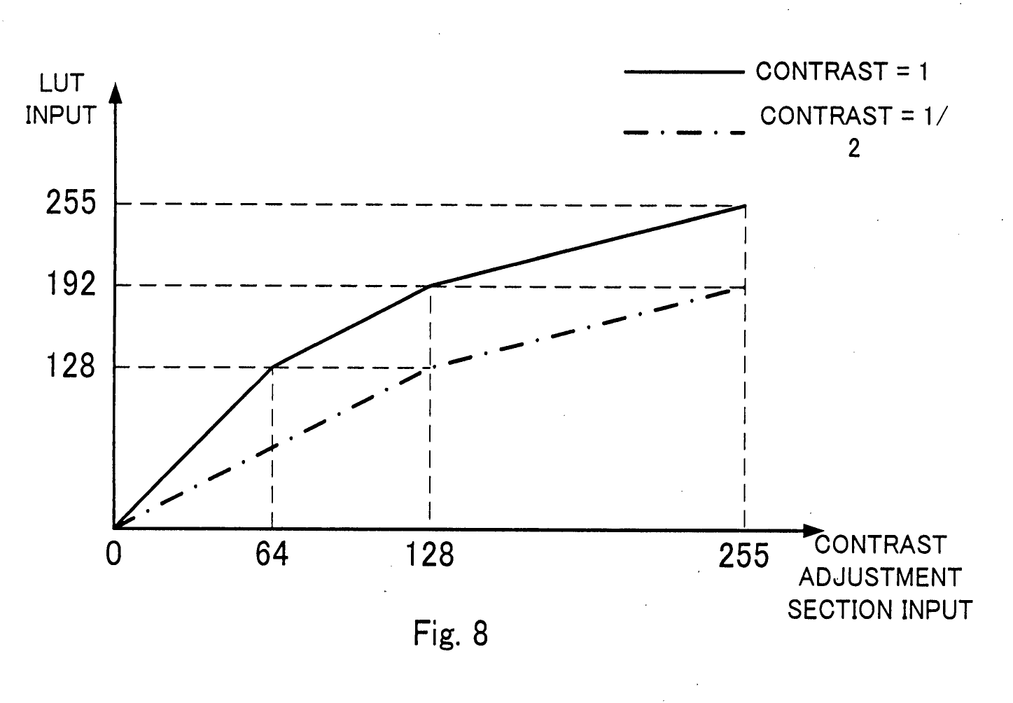

FIG. 8 shows a relationship between the input data to the contrast adjustment section 11 and the input data to the gamma correction LUT 14. In FIG. 8, the solid line indicates the relation when the contrast is 1, while the dash-and-dot line indicates the relation when the contrast is ½.

First, when the contrast is 1, the range from 0 to 63 of the input data to the contrast adjustment section 11 corresponds to the range from 0 to 126 of the input data to the LUT 14, which shows a relationship in which the input to the LUT 14 increases by 2 as the input to the contrast adjustment section 11 increases by 1, as shown by the solid line in FIG. 8. However, this is the case where the lowest bits of the outputs from the contrast adjustment section 11 and from the bit width reduction section 12 by which the output from the contrast adjustment section 11 is compressed are taken, not as fractional portions, but as integer values, which applies hereafter, as well. The range from 64 to 127 of the input data to the contrast adjustment section 11 corresponds to the range from 128 to 191 of the input data to the LUT 14, which shows a relationship in which the input to the LUT 14 increases by 1 as the input to the contrast adjustment section 11 increases by 1. The range from 128 to 255 of the input data to the contrast adjustment section 11 corresponds to the range from 192 to 255 of the input data to the LUT 14, which indicates a relationship in which the input to the LUT 14 increases by 1 as the input to the contrast adjustment section 11 increases by 2. Therefore in this case, there can be expressed 64 gradations in the range from 0 to 63 of the input to the contrast adjustment section 11, 64 gradations in the range from 64 to 127, and 64 gradations in the range from 128 to 255, or a total of 192 gradations.

When setting the contrast to ½, the highest bit of the 9-bit output from the contrast adjustment section 11 becomes 0, and the value of the lower 8 bits becomes equal to the input data. Therefore, as shown by the dotted line in FIG. 8, the range from 0 to 127 of the input data to the contrast adjustment section 11 corresponds to the range from 0 to 127 of the input to the LUT 14, which shows a relationship in which the input to the LUT 14 increases by 1 as the input to the contrast adjustment section 11 increases by 1. The range from 128 to 255 of the input data to the contrast adjustment section 11 corresponds to the range from 128 to 191 of the input to the LUT 14, which shows a relationship in which the input to the LUT 14 increases by 1 as the input to the contrast adjustment section 11 increases by 2. Therefore, there can be expressed 128 gradations in the range from 0 to 128 of the input and 64 gradations in the range from 128 to 255, which can express a total of 192 gradations.

Without using the bit width reduction section 12, the gradation becomes 256 when the contrast is set to be 1, while the gradation is reduced by half, to 128, when the contrast is set to ½. However the use of the bit width reduction section 12 as in this embodiment makes it possible to maintain substantially constant number of gradations, which shows an effective using of the LUT 14.

According to the example of FIG. 7 as described above, because the bit width of the input to the gamma correction LUT 14 can be made greater by extending the bit width of the input signal in the contrast adjustment section 11, the effect as disclosed in JP-A-2002-165111, that the correction accuracy in the black region with high slope of gamma correction curve can be improved, can be obtained. Further in this example, the bit width of the input signal to the LUT 14 can be reduced by compressing the bit width of the signal with the greater bit width by the bit width reduction section 12, while maintaining thus improved correction accuracy in the black region. Therefore, effects nearly identical to those obtained in the related art of JP-A-2002-165111 can be realized by the LUT 14, but with a smaller LUT size than the conventional art.

Although an example of a digital video signal data processor for gamma correction has been described, it is also possible to configure the present invention by providing digital video signal data processor for the signal of each color R, G and B in an actual display system.

In the above, a bit width reduction section 12 for reducing the bit width by 1 bit by selecting data with the use of higher 2 bits of the input data was described as an example, and it is to be understood that this is only an example. For example, the same concept can be applied to a bit width reduction section 12 for reducing the bit width by 2 bits.

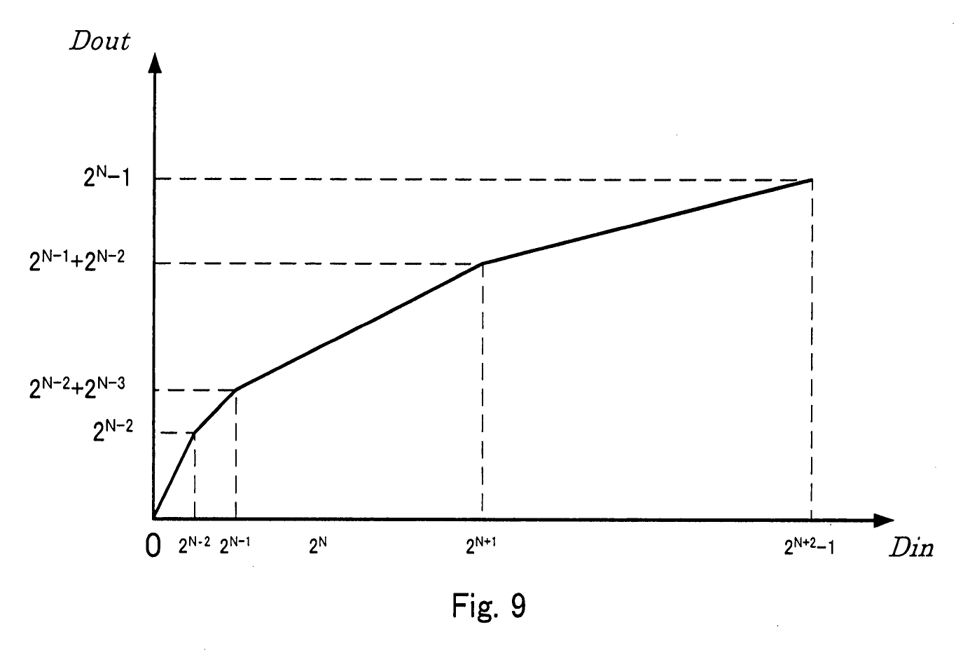

FIG. 9 shows the input/output characteristics of the bit width reduction section 12 in which the bit width is reduced by two bits. The characteristic is shown by the following formula:

$$Dout = \{ \begin{matrix}Din & ( 0 \leq Din \leq {2}^{N - 2} - 1 ) \\ Din / 2 + {2}^{N - 3} & ( {2}^{N - 2} \leq Din \leq {2}^{N - 1} - 1 ) \\ Din / 4 + {2}^{N - 2} & ( {2}^{N - 1} \leq Din \leq {2}^{N + 1} - 1 ) \\ Din / 8 + {2}^{N - 1} & ( {2}^{N + 1} \leq Din \leq {2}^{N + 2} - 1 )\end{matrix} \qquad ( 2 )$$

In the characteristic, in the lowest (that is, low luminance side) one-sixteenth of the input signal Din, the value of the output signal Dout is same as the value of the input signal Din, and the slope of graph showing the characteristic is 1. In the next lowest one-sixteenth of the input signal Din, the slope of graph showing the characteristic is ½. In the next three-eighths of the input signal Din, the slope of graph showing the characteristic is ¼. In the higher half of the input signal Din, the slope of graph showing the characteristic is ⅛. With this characteristic, the input signal of (N+2) bits can be compressed to N-bit width while maintaining the gradation on the low luminance side.

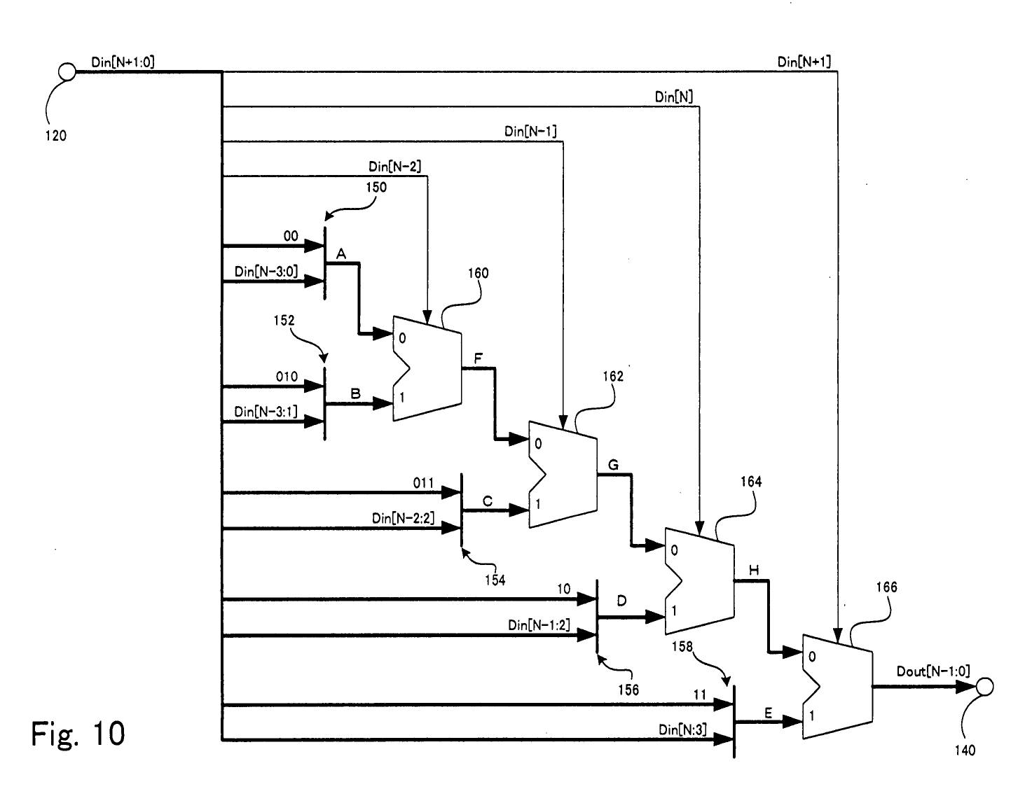

FIG. 10 shows an example of an internal configuration of the bit width reduction section 12 realizing this characteristic. In the example of FIG. 5 where the bit width is reduced by 1 bit, there are used three data merging sections 122, 124 and 126 and two selectors 130 and 132, however in the example of FIG. 10 where the bit width is reduced by 2 bits, on the other hand, there are used five data merging sections 150, 152, 154, 156 and 158 and four selectors 160, 162, 164 and 166.

In this example, the data merging section 150 generates data A of N bit by merging “00” into the high order side of “Din[N−3:0]” of the lower (N−2) bit of the input signal Din (Din[N+1:0]) of (N+2) bit. The data merging section 152 generates data B of N bit by merging “010” into the high order side of (N−3)-bit Din[N−3:1] from the second bit from the lower bit (place number 1) to the fifth bit from the higher bit (place number N−3) of the input signal Din. The data merging section 154 generates data C of N bit by merging “011” into high order side of (N−3)-bit Din[N−2:2] from the third bit from the lower bit (place number 2) to the fourth bit from the higher bit (place number N−2) of the input signal Din. The data merging section 156 generates data D of N bit by merging “10” into high order side of (N−2)-bit Din[N−1:2] bit from the third bit from lower bit to the third bit from higher bit of the input signal Din. The data merging section 158 generates data E of N bit by merging “11” into high order side of (N−2)-bit Din[N:3] bit from the fourth bit from the lower bit to the second bit from the higher bit of the input signal Din.

The selector 160 receives the data A and B, outputs data A when the value of the fourth bit (Din [N−2]) from higher bit of Din is 0, and outputs the data B when the value is 1. Similarly, the selector 162 receives the output data F from the selector 160 and data C, outputs data F when the value of the third bit (Din[N−1]) from higher bit of Din is 0, and outputs the data C when the value is 1. The selector 164 receives the data G output from the selector 162 along with data D, outputs data G when the value of the second bit (Din[N]) from higher bit of Din is 0, and outputs the data D when the value is 1. The selector 166 receives the data H output from the selector 164 along with data E, outputs data H when the value of the highest bit (Din[N+1]) of Din is 0, and outputs the data E when the value is 1.

The example shown in FIGS. 9 and 10 makes possible a bit width compression of 2 bits.

The invention has been described in detail with particular reference to certain preferred embodiments thereof, but it will be understood that variations and modifications can be effected within the spirit and scope of the invention.

### Parts List

1 driving TFT
2 organic EL element
3 switching TFT
10 image operation section
11 contrast adjustment section
12 bit width reduction section
14 gamma correction LUT
18 organic EL panel
120 input section
122 data merging section
124 data merging section
126 data merging section
130 selector
132 selector
140 output section
150 data merging section
152 data merging section
154 data merging section
156 data merging section
158 data merging section
160 selector
162 selector
164 selector
166 selector

1. A digital video signal data processor comprising:
a data conversion section for converting an input digital video signal data such that a gradation of the signal data within a signal level range can be finer than gradations within other signal level ranges; and
a gamma correction table for performing a gamma correction on an input converted video signal data which was output from the data conversion section.

2. A digital video signal data processor according to claim 1, wherein the data conversion section is a bit width reduction section for reducing a bit width of the digital video signal data by maintaining the gradation within the protection signal level range in which the gradation is to be protected and by compressing the gradation by rounding one or more lower-order bits within signal level ranges in the input digital video signal data other than the signal level range in which the gradation is to be protected.

3. A digital video signal data processor according to claim 1, wherein the data conversion section comprises:
a contrast adjustment section for multiplying a contrast coefficient for the digital video signal data which has been input and for outputting output video signal data with greater bit width than the digital video signal data; and
a bit number reduction section for reducing a bit number of the output video signal data in accordance with an input bit width of the gamma correction table by maintaining the gradation within the signal level range in which the gradation is to be protected and by compressing the gradation by rounding one or more lower-order bits within other signal level ranges in the output video signal data output from the contrast adjustment section.

4. A digital video signal data processor according to claim 2, wherein the bit width reduction section compresses the gradation relatively largely as a luminance of the signal level range becomes high, by making a proportion of an increase in output to an increase in input small as the luminance of the signal level range becomes high.

5. A digital video signal data processor according to claim 4, wherein the bit width reduction section comprises:
a data merging section for generating an output increasing linearly relatively to an increase in input by dividing the signal level range of the digital video signal data which has been input to a plurality of signal levels which can be identified by values of several bits on higher-order side in order of the signal level range with a highest-order bit 1, the signal level range with a highest-order bit 0 and a second-order bit 1 and so on and by merging higher-order bits representing a range with a part of the digital video signal data in each signal level range; and
a selector for selecting each output from the data merging section by each bit of higher-order of the digital video signal data.

6. A digital video signal data processor according to claim 5, wherein the bit width reduction section compresses an input Din of (N+1) bit width to an output Dout of N bit width by the following formula:
$$Dout = \{ \begin{matrix}Din & ( 0 \leq Din \leq {2}^{N - 1} - 1 ) \\ Din / 2 + {2}^{N - 2} & ( {2}^{N - 1} \leq Din \leq {2}^{N} - 1 ) \\ Din / 4 + {2}^{N - 1} & ( {2}^{N} \leq Din \leq {2}^{N + 1} - 1 )\end{matrix} \qquad ( 1 )$$

7. A digital video signal data processor according to claim 5, wherein the bit width reduction section compresses an input Din of (N+2) bit width to an output Dout of N bit width by the following formula:
$$Dout = \{ \begin{matrix}Din & ( 0 \leq Din \leq {2}^{N - 2} - 1 ) \\ Din / 2 + {2}^{N - 3} & ( {2}^{N - 2} \leq Din \leq {2}^{N - 1} - 1 ) \\ Din / 4 + {2}^{N - 2} & ( {2}^{N - 1} \leq Din \leq {2}^{N + 1} - 1 ) \\ Din / 8 + {2}^{N - 1} & ( {2}^{N + 1} \leq Din \leq {2}^{N + 2} - 1 )\end{matrix} \qquad ( 2 )$$

8. A digital video signal data processor according to claim 1, wherein the digital video signal data which has been gamma-corrected by the gamma correction table is supplied to an organic EL light emitting element or a liquid crystal display element.
